(19) United States
(12) Patent Application Publication
(10) Pub. No.: US 2011/0311297 A1
(43) Pub. Date: Dec. 22, 2011

(54) Tool for marking decorative lines or strips

(76) Inventor: Giuliano Cazzola, Monticello Conte Otto (VI) (IT)

(21) Appl. No.: 13/128,186

(22) PCT Filed: Dec. 24, 2008
(86) PCT No.: PCT/IB2008/055527

§ 371 Date: Aug. 3, 2011

(30) Foreign Application Priority Data
Nov. 7, 2008 (IT) VI2008A000261

(51) Int. Cl. B05C 17/035

(52) U.S. Cl. 401/147

(57) ABSTRACT

A tool for marking decorative lines or strips on a surface comprising a main frame (2) that defines a longitudinal axis (L)1 a handle (3) fixed to said frame (2), a first deposition roller (4) rotatably mounted to said frame (2) to rotate about a first substantially transverse axis (A) and having an outer peripheral portion (14) conformed for marking a line or a decorative strip (H)1 means (5) for feeding said deposition roller (4) with a pigmented liquid. The feeding means (5) comprise a second collecting roller (7) mounted to the frame (2) and made of a substantially porous material designed to absorb the pigmented liquid and transfer it in a substantially continuous and controlled manner to the first roller (4) as the latter rolls over the surface (S) to be decorated.

### FIELD OF THE INVENTION

The present invention generally finds application in the field of tools for applying liquids to surfaces in general, and particularly relates to a tool for marking decorative lines and strips with a pigmented liquid, such as a paint or the like, over flat or curved surfaces, such as interior and exterior walls, panels and the like.

### BACKGROUND OF THE INVENTION

Decorative marking of lines or thin strips of paint or other pigmented liquids over flat or convex surfaces, such as walls of buildings, columns, panels, vehicle bodies and the like, requires great skill from the operator to obtain regular and continuous marks.

Typically, the operator places a guide, such as a ruler or another equivalent tool, on the surface to be decorated and then marks the colored strips using a paintbrush, a roller or another suitable tool.

This operation requires considerable manual skill from the operator to avoid smears and obtain regular marks. Furthermore, a limited amount of liquid can be generally drawn from the tool, which does not allow continuous marking of long strips, and involves considerable time consumption and skilled labor.

In an attempt to simplify marking and continuously paint relatively long and consistent marks, a variety of tools have been provided, which have a paintbrush or roller marker element connected to a reservoir for the paint or pigmented liquid.

For instance, from U.S. Pat. No. 7,427,427 discloses a tool for making strips of paint is known, which comprises a roller connected to a cylindrical reservoir for feeding liquid, in which a piston slides for pressing liquid towards the roller.

These known tools have the drawback of not allowing the roller to be properly fed with the liquid to be transferred to the surface, wherefore paint marks may be irregular and liquid dripping may occur.

### SUMMARY OF THE INVENTION

The object of the present invention is to obviate the above drawbacks, by providing a tool for marking decorative strips, particularly strips of paint or other pigmented liquids, to be spread over a flat or curved surface.

A particular object of the present invention is to provide a marking tool which allows precise, regular edged marks to be painted over any surface.

Another object of the invention is to provide a marking tool which allows consistent transfer of the proper amount of liquid to the surface to be decorated.

Yet another object of the present invention is to provide a marking tool that is easy to use and requires no particular skill from the user.

These and other objects, as better explained hereafter, are fulfilled by a tool for marking decorative lines or strips over a surface as defined in claim 1.

By this configuration, the tool will provide continuous and regular decorative lines and strips, and avoid any smearing, inconsistency, undulation or liquid dripping.

Advantageous embodiments of the invention are defined in accordance with the dependent claims.

### BRIEF DESCRIPTION OF THE DRAWINGS

Further features and advantages of the invention will be more apparent from the detailed description of a preferred, non-exclusive embodiment of a tool according to the invention, which is described as a non-limiting example with the help of the annexed drawings, in which:

FIG. 1 is a top view of a tool of the invention;

FIG. 2 is a side view of the tool of FIG. 1;

FIG. 3 is a perspective top view of the tool of FIG. 1.

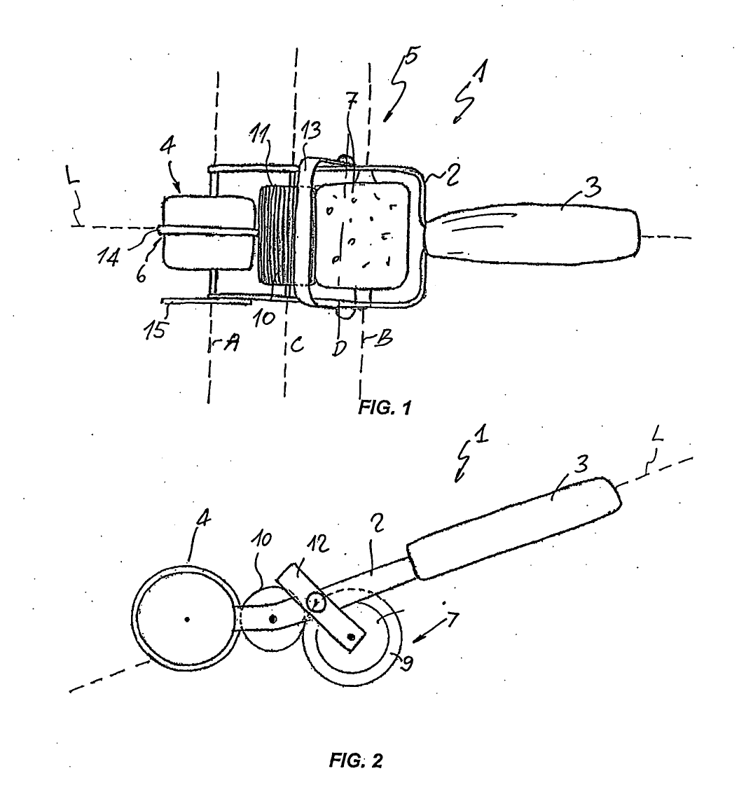

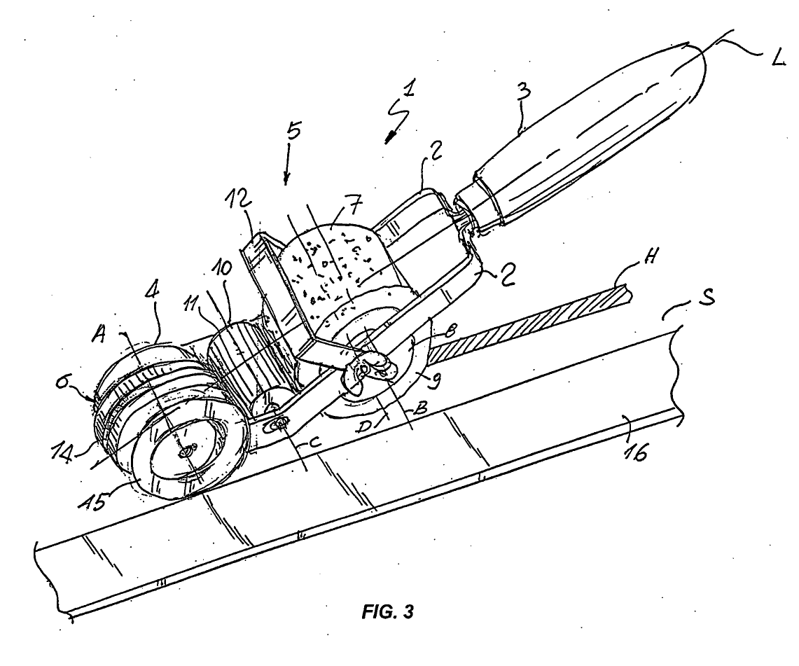

### DETAILED DESCRIPTION OF A PREFERRED EMBODIMENT

Referring to the above figures, the tool of the invention, generally designated by numeral 1, will be particularly suitable for marking decorative lines, strips—sometimes known as “rules”—of paint or other pigmented liquids over a flat or curved surface.

The surfaces to be decorated may include interior or exterior walls of buildings, columns and products in general, or even panels and vehicle bodies.

According to the invention, the tool 1 comprises a main frame 2 that defines a longitudinal axis L and has a first end with a handle 3 made of wood or another similar material.

The frame 2 may be of any shape, although in a preferred embodiment it may be substantially U-shaped, as shown.

At the end of the frame 2 opposite the handle 3, a first roller 4 is provided for depositing the pigmented liquid which is designed to contact a surface to be decorated S to mark a decorative strip or line H thereon.

The deposition roller 4 is rotatably mounted to the frame 2, for example for rotating about a first transverse axis A.

Feeding means, generally designated by numeral 5, are provided for spreading the pigmented liquid.

The deposition roller 4 further has an outer peripheral portion 6 which is conformed for marking a line or a decorative strip H.

According to a peculiar feature of the present invention, the feeding means 5 comprise a second collecting roller 7 mounted to the frame 2 and made of a substantially porous material designed to absorb the pigmented liquid and transfer it in a substantially continuous and controlled manner to the first deposition roller 4 as the latter rolls over the surface S to be decorated.

Particularly, the second collecting roller 7 is rotatably mounted about a second axis B substantially transverse to the frame and parallel to the first axis A, in a position offset therefrom.

For instance, the collecting roller 7 may include an inner cylindrical support portion 8, pivoting about the second transverse axis B and made of any metal of plastic material of adequate strength and an elastically yielding porous and spongy material to absorb and retain the pigmented liquid.

The spongy material used for the peripheral portion 9 of the porous collecting roller 7 may be any material commonly used to make rollers for painting and masonry in general and whose liquid absorption capacity is selected according to the particular application for which the tool is designed.

As shown in the figures, the feeding means 5 may include a third transfer roller 10 for drawing the liquid contained in the spongy peripheral roller 9 of the collecting roller 7 and transferring it to the deposition roller 4.

The transfer roller 10 may be rotatably mounted to a third axis C substantially parallel and interposed between the first two axes A, B.

Conveniently, the third axis C will have an appropriate longitudinal position adapted to hold the transfer roller 10 constantly in contact with the deposition roller 4 and selectively in contact with the peripheral portion 9 of the collecting roller 7.

Thus, the third transfer roller 10 may transfer the pigmented liquid that has been drawn from the collecting roller 7 to the deposition roller 4 due to the relative rotation therewith.

Preferably, the transfer roller 10 may also have a splined outer lateral surface, with transverse or helical parallel grooves 11, defining a plurality of peripheral channels adapted to contain the liquid and increase the amount of liquid that can be drawn upon rolling contact with the spongy peripheral portion 9 of the collecting roller 7.

As shown in the figures, the transfer roller 10 and the porous collecting roller 7 may be tangent to each other, or have a slight interference fit relationship to cause the spongy peripheral portion 9 to be radially pressed and facilitate liquid passage.

In a particularly advantageous aspect, the invention may provide means for controlling the amount of liquid drawn by the collecting roller.

Particularly, the control means may include a movable secondary frame 12 pivoting about the frame 2 by its median portion about a fourth transverse axis D, substantially parallel to the first three axes A, B, C.

Advantageously, the collecting roller 7 will be rotatably mounted about its axis of rotation B at one end of the movable secondary frame 12. The other end 13 of the secondary frame 12 will be free and adapted to be driven by the user to cause the collecting roller 7 to be pressed against the transfer roller 10.

Thus, the collecting roller 7 may be caused to translate in the longitudinal direction relative to the transfer roller 10 to control the amount of liquid to be transferred to the deposition roller 4.

This configuration will be particularly useful to allow the use of all the liquid contained in the spongy peripheral portion 9 and particularly to draw the liquid held in the innermost layers of the spongy material when the liquid contained in the outer layers thereof has been entirely transferred to the deposition roller 4.

This will provide the unquestionable advantage of increasing the operation time of the tool, which allows relatively long decorative strips to be marked without supplying any further liquid into the collecting roller 7, thereby ensuring a consistent and aesthetically pleasant effect.

The deposition roller 4 may have a substantially cylindrical shape, with an axial dimension selected according to the desired transverse dimension of the decorative strip H.

Nonetheless, the roller 4 may have one or more ring-like projections 14 over at least part of its outer peripheral portion 6, which are designed to contact the transfer roller 10 to receive the liquid to be deposited over the surface to be decorated. This configuration will be particularly useful for marking relatively thin decorative strips.

Furthermore, while the configuration of the figures includes a single central ring-like projection 14, two or more transversely offset projections may be provided for simultaneous marking of a corresponding number of strips.

A disk 15 may be attached to the frame, level with the deposition roller 4, which will define an abutment surface against a guide template, ruler or rod 16, to guide the tool in its motion.

This will allow simple and quick painting of decorative strips, while providing a pleasant aesthetic effect with no particular manual skill requirement. The use of curved templates or rulers will also allow simple painting of curves strips.

According to a further embodiment, also not shown in the present figures, the feeding means may include a tank for the pigmented liquid, which is associated with the collection roller 7 to regularly feed it with the pigmented liquid.

For example, the tank may be a small external tank mounted to the frame 2 and directly connected by a pipe to the spongy peripheral portion 9 and appropriately closed to allow the tool 1 to be used in any inclination.

The tool 1 may further include motor means, such as a small battery-operable micro motor, associated with at least one of the transverse axes A, B, C for imparting a starting torque and facilitate dry start of the deposition roller 4.

In a further aspect of the invention, whose embodiment is not shown herein, the frame 2 may have a male element, such as a pin or a transverse projecting member, which is suitably shaped for slideable engagement in a straight or curved guide channel, formed in a guide profile or rail, which is designed to be fixed to the wall surface S to guide the tool during the rolling motion of the deposition roller 4.

The guide channel may have a retention roller adapted for cooperation with the male element and prevent transverse disengagement between the frame 2 and the guide profile.

The male element may have any shape, e.g. a cylindrical, prismatic, T, or the like shape, or may be part of the guide profile and be coupled to the frame 2 with a female receptacle formed therein, not shown.

The above description clearly shows that the invention fulfils the intended objects, and particularly the object of providing a tool for marking decorative strips which allows strips of paint or any other pigmented liquid to be simply and quickly marked on any surface, while consistently ensuring a pleasant aesthetic effect.

The tool of the invention is susceptible to a number of changes and variants, within the inventive principle disclosed in the appended claims. All the details thereof may be replaced by other technically equivalent parts, and the materials may vary depending on different needs, without departure from the scope of the invention.

While the tool has been described with particular reference to the accompanying figures, the numerals referred to in the disclosure and claims are only used for the sake of a better intelligibility of the invention and shall not be intended to limit the claimed scope in any manner.

1. A tool for marking decorative lines or strips on a surface, such as a wall surface or the like, comprising:
a main frame (2) defining a longitudinal axis (L);
a handle (3) fixed to said frame (2);
a first deposition roller (4) rotatably mounted on said frame (2) to rotate about a first substantially transverse axis (A), said first roller (4) having an external peripheral portion (14) conformed for marking a line or a decorative strip (H) on a surface (S) to be decorated;
means (5) for feeding said deposition roller (4) with a pigmented liquid; characterized in that said feeding means (5) comprise a second collecting roller (7) mounted on said main frame (2) and made of a substantially porous material designed to absorb the pigmented liquid and to transfer it in a substantially continuous and controlled manner to said first roller (4) upon the rolling of this latter on the surface (S) to be decorated.

2. Tool as claimed in claim 1, characterized in that said collecting roller (7) is rotatably mounted on said frame (2) about a second axis (B) substantially parallel and in offset relationship with respect of said first axis (A).

3. Tool as claimed in claim 2, characterized in that said feeding means (5) comprise a third transfer roller (10) mounted on said frame (2) on a third axis (C) substantially parallel to said first and said second axis (A, B).

4. Tool as claimed in claim 3, characterized in that said third transfer roller (10) is mounted in an intermediate position with respect to said first two rollers (4, 7) with its external cylindrical surface continuously in contact engagement with the external surface of said first roller (4).

5. Tool as claimed in any of the preceding claims, characterized in that said second collecting roller (7) is rotatably mounted to an end of said movable secondary frame (12) having a middle portion pivoted on said main frame (2) around a fourth axis (D) substantially parallel to the first three (A, B, C).

6. Tool as claimed in claim 5, characterized in that said movable secondary frame (12) has the opposite end (13) actuatable by a user to force the external peripheral portion (9) of said collecting roller (7) against said transfer roller (10).

7. Tool as claimed in any preceding claims, characterized in that said transfer roller (10) has a splined external peripheral surface to promote a uniform distribution of pigmented liquid.

8. Tool as claimed in any preceding claims, characterized in that the peripheral portion of said first deposition roller (4) has at least one ring-like projection (14) with a width adapted to define said decorative strip or line (H).

9. Tool as claimed in claim 8, characterized in that said at least one ring-like projection (14) is made of an elastically yielding material selected in the group comprising natural and synthetic rubbers such as silicon rubbers, latex and the like.

10. Tool as claimed in any preceding claims, characterized by comprising a disk (15) in a relatively rigid material laterally mounted on said main frame (2) and centered on said first axis (A), said disk (15) being susceptible to come into contact with a guide rail or line (16) firmly leaned on the surface (S) to be decorated in such a manner to guide the tool during the rolling of said deposition roller (4) on the surface (S) to be decorated.

11. Tool as claimed in any of the preceding claims, characterized by comprising a guide profile susceptible to be fixed to a surface (S) to be decorated and provided with a guide groove extending lengthwise thereof, said main frame (2) having a shaped male member projecting along a substantially transverse direction to slidingly engage said guide groove and to guide said tool during the rolling of said deposition roller (4) on the surface (S) to be decorated, said guide groove being provided with a holding surface designed to cooperate with said male member to prevent the transverse detachment of said frame (2) from said profile.

12. Tool as claimed in any of the preceding claims, characterized in that said feeding means (5) further comprise a reservoir for the pigmented liquid connectable to said second collecting roller (7) to continuously supply it during use.

13. Tool as claimed in any of the preceding claims, characterized by comprising motor means connectable to at least one between said first, second and a third transverse axis (A, B, C) to promote the rotation and starting rolling of saying first roller (4) on the surface (S) to be decorated.
